(19) United States
(12) Patent Application Publication
(10) Pub. No.: US 2012/0253958 A1
(43) Pub. Date: Oct. 4, 2012

(54) SYSTEM FOR GENERATING DIGITAL RECEIPTS

(75) Inventors: Birame Sock, Miami Beach, FL (US); John Crichton-McCutcheon, Pembroke Pines, FL (US)

(73) Assignee: THIRD SOLUTIONS, INC., Miami Beach, FL (US)

(21) Appl. No.: 13/078,533

(22) Filed: Apr. 1, 2011

(51) Int. Cl. G06Q 20/00

(52) U.S. Cl. 705/21

(57) ABSTRACT

A digital receipt generator is placed between a point of sale terminal and a printer. The digital receipt generator receives receipt printing requests from the point of sale terminal, identifies the customer making the purchase, and transmits the receipt data to a printer, to a central server or to both.

### BACKGROUND OF THE INVENTION

1. Field of the Invention

The field of the present invention is transaction data processing. In particular, the field of the invention is directed towards generating digital receipts.

2. Description of the Related Technology

Most retailers understand that many aspects of our lives are managed digitally and, in particular, most aspects of our financial lives are managed in a digital, on-line environment. However, the vast majority of retailers with “brick and mortar” stores only offer paper receipts to their customers because they are unable to offer a digital solution.

Today, in order to provide its customers with digital receipts, a retailer needs to build its own solution to be used solely by that retailer or integrate a third party digital receipts solution into its point of sale system. Building an internal solution has several limitations. For example, many small to mid-sized retailers do not have an internal information technology department that can develop a digital receipts solution for the retailer. Such retailers might be able to outsource the development of a digital receipts solution, however such work is likely to be costly and, once complete, would require support and maintenance that the retailer is unable to manage.

Regardless of whether a retailer is able to develop an internal solution itself or outsource the development of a solution, the end product would not be ideal for the customer as he or she would have to deal with delivery of digital receipts from different retailers in different ways depending on the solution it offers. For example, some retailers might make a receipt available in a customer account on their store website.

Integrating with a third party digital receipts solution that offers a global receipts platform solves many of the problems described above and permits the customer to receive his or her receipts from multiple retailers in one location, in a consistent format. However, such a global digital receipts solution may not be readily available to the retailer if it is not already integrated with the retailer's point of sale provider or if integration is made difficult due to a highly customized or uncommon point of sale system. A retailer may also decide that it is not ready to integrate directly with a third party digital receipts solutions based on cost, retailer size or technical know-how.

A retailer would be able to avoid the issues described above if it could provide digital receipts to its customers without involving any modification to, or upgrade of, its point of sale system, however such a solution is not currently available.

### SUMMARY OF THE INVENTION

An object of the present invention is receipt capture.

Another object of the present invention is a digital receipt generator.

Still another object of the present invention is a system for generating a digital receipt.

Still yet another object of the present invention is a method for generating a digital receipt.

An aspect of the present invention may be a system for generating digital receipts comprising: a point of sale terminal, wherein the point of sale terminal processes transaction data and generates a print request; a receipt generator operably connected to the point of sale terminal, wherein the receipt generator generates a digital receipt in response to the print request; and a central server operably connected to the receipt generator wherein the central server receives the digital receipt.

Another aspect of the present invention may be a method for generating a digital receipt comprising: processing transaction data at a point of sale terminal; intercepting a print request from the point of sale terminal; receiving the print request at a receipt generator operably connected to the point of sale terminal; generating a digital receipt; and forwarding the digital receipt to a central server.

Still yet another aspect of the present invention may be a digital receipt generator comprising: connecting means adapted for connecting to a point of sale terminal; receiving means for receiving the print request from the point of sale terminal; generating means for generating a digital receipt from the print request; a customer interface for entering user supplied information; and transmitting means for transmitting the digital receipt to a central server.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 shows an embodiment of a system for generating digital receipts.

FIG. 2 shows another embodiment of the system for generating digital receipts.

FIG. 3 shows another embodiment of the system for generating digital receipts.

FIG. 4 is a flow chart showing the method for generating digital receipts in the system.

FIG. 5 is a flow chart showing the detailed method for generating digital receipts.

### DETAILED DESCRIPTION OF THE PREFERRED EMBODIMENT(S)

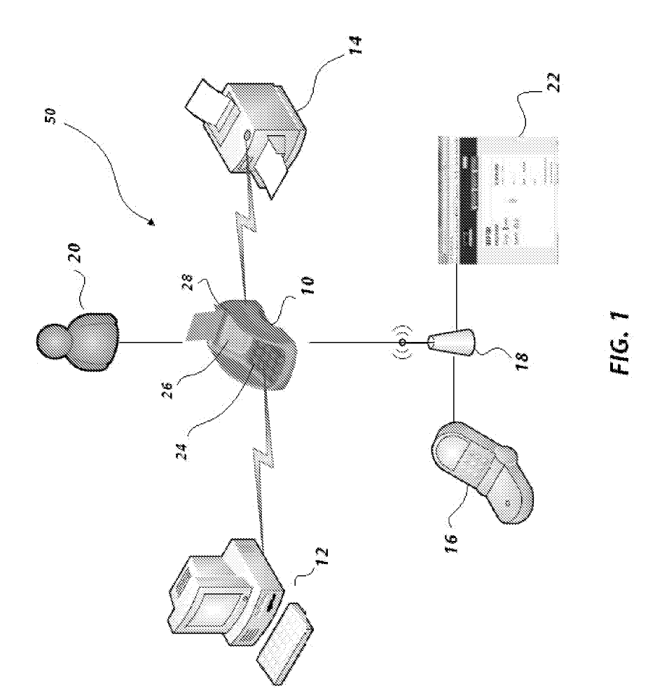

FIGS. 1-3 show embodiments of digital receipt generating systems 50, 60 and 70. Like numerals represent similar structure throughout the application.

Shown in FIG. 1 is the digital receipt generating system 50 that employs the digital receipt generator 10. Digital receipt generating system 50 is designed to be usable with existing transactions systems found in retailers and other transactional based establishments.

In FIG. 1 a point of sale (POS) terminal 12 is shown. The point of sale terminal 12 may be a computer terminal dedicated to processing transactions generated by a user 20. The system and method may be used with pre-existing POS terminals 12 these systems may be retro-fitted with ease in order to provide digital receipts. For merchants this means that they do not have to update their entire systems and are able to use existing equipment with the system and method of the present invention.

Operably connected to the POS terminal 12 is a digital receipt generator 10. The digital receipt generator 10 may be operably connected to the point of sale terminal 12 via short-range wireless connectivity, e.g. bluetooth, a wired network connection, a USB connection or a parallel port. The digital receipt generator 10 may have the capability of using the various types of connecting means in order to connect to the POS terminals 12 so as to maximize the ways in which the digital receipt generator 10 can be connected to existing technology. The digital receipt generator 10 may also be adapted to automatically install digital receipt software 40 on the POS terminal 12 when connected.

The digital receipt generator 10 may additionally be connected to a POS printer 14. The digital receipt generator 10 may be connected in the same in manner in which it is connected to the POS terminal 12.

The digital receipt generator 10 may have a display 26, a magnetic strip reader 28 and a number pad 24. The display 26 provides information to the user 20 so that the user 20 may select which options to take. The number pad 24 is provided so that the user 20 may enter identification data, such as a telephone number. The magnetic strip reader 28 is provided to read identification data from cards. It is further contemplated that other technologies may be employed on the digital receipt generator 10 so as to obtain identification data about the user 20. For example, the digital receipt generator 10 may use RFID technology to identify the user 20.

The digital receipt generator 10 is further operably connected to a central server 18. The central server 18 may include one or more of the following; a receipt database, an email server, communication servers, receipt storage databases, data analysis tools, and value added applications. The central server 18 receives the digital receipt data and may store the data for later access. The central server 18 may further transmit the digital receipt data to a user 20 for access on a web site 22, or via a mobile device 16.

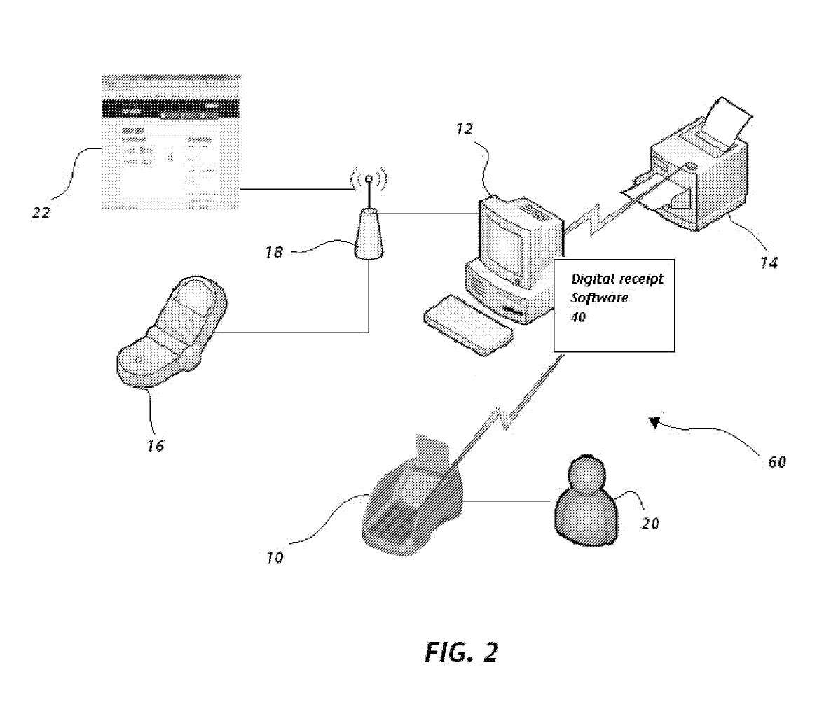

FIG. 2 shows digital receipt generating system 60, which is an alternative embodiment of the system. In system 60 the digital receipt generator 10 is operably connected to the POS terminal 12. The POS terminal 12 may have digital receipt software 40 installed thereon. The POS terminal 12 may be directly connected to the central server 18, which may then transmit digital receipts to a web site 22 or a mobile device 16. In this system 60 the digital receipt software 40 operates in conjunction with the digital receipt generator 10.

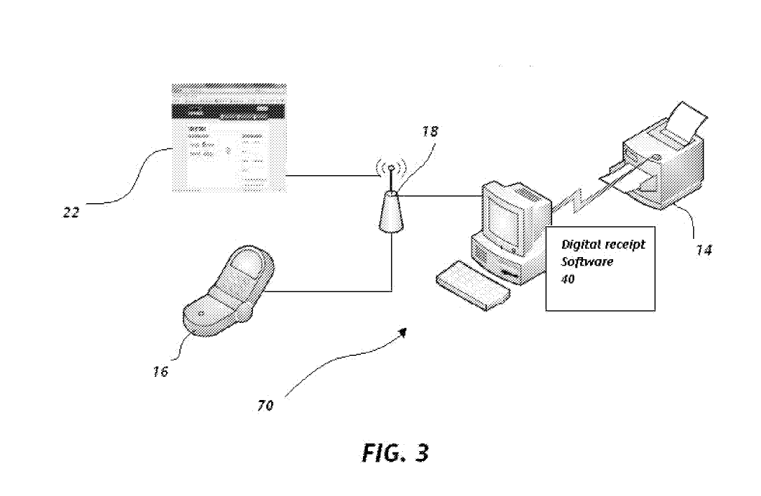

FIG. 3 shows an alternative embodiment of the digital receipt generating system 70. In system 70 the digital receipt software 40 is located on the POS terminal 12 and is capable of transmitting the data directly to either the POS printer 14 or a central server 18. In this system 70 the digital receipt software 40 assumes the functionality of the digital receipt generator 10 and houses it on the POS terminal 12.

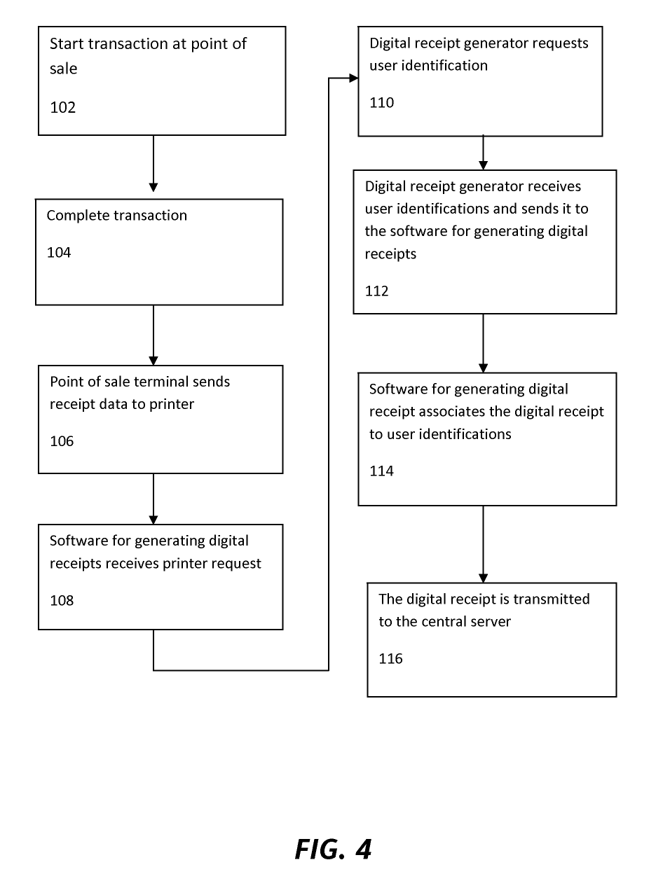

FIG. 4 is a flow chart showing the detailed method for generating a digital receipt. In step 102 a transaction is started at a POS terminal 12. The transaction may typically be the purchase of items or services by a user 20. In step 104, the transaction is completed at the POS terminal 12. In step 106 the POS terminal 12 generates receipt data and prepares to send the receipt data to a POS printer 14 via a print request.

In step 108, the digital receipt generator 10 and/or the digital receipt software 40 that is installed on the POS terminal 12 is able to intercept the print request. If intercepted by the digital receipt software 40 it may transfer the request to the digital receipt generator 10. It should further be understood that in the embodiment of the system 70 shown in FIG. 3, the digital receipt software 40 is adapted to transmit the digital receipt data directly to either the central server 18 or the POS printer 14, or to both. In step 110, the digital receipt generator 10 may request that the user 20 provide credentials. In step 112, the digital receipt generator 10 receives the identification of the user 20 and processes it.

In step 114, the digital receipt software 40 or the digital receipt generator 10 associates the digital receipt to the user identifications. In step 116, the digital receipt may be transmitted to a central server 18, the digital receipt generator 10 may also then forward the print request for the receipt to the POS printer 14. The digital receipt may then be stored and sorted by the user. The digital receipt may contain various pieces of data, such as transaction data, e.g. the date and time of the transaction, the merchandise purchased, offers accepted, promotions entered into, and/or payment data. The transaction data may also include the user identification, the merchant data and the digital receipt generator's identification number.

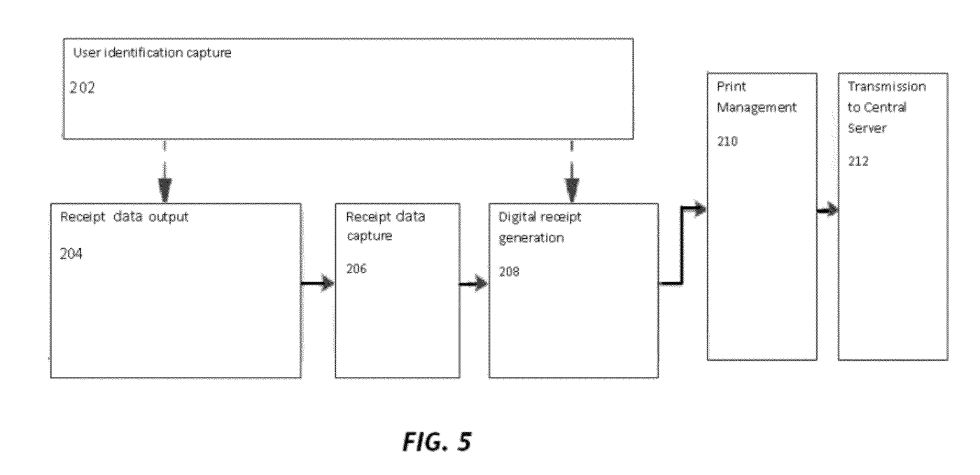

FIG. 5 is a flow chart showing the detailed method for generating digital receipts. In step 202 the user identification may be captured either in step 204, which is the output of the receipt data, or at step 208, which is the generation of the digital receipt. After the output of the receipt data, in step 208 the receipt data is intercepted. In step 208, the receipt is used to generate the digital receipt. In step 210, print management occurs and a physical copy of the digital receipt is produced and/or at step 212 the digital receipt is transmitted to the central server.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A system for generating digital receipts comprising:
a point of sale terminal, wherein the point of sale terminal processes transaction data and generates a print request;
a receipt generator operably connected to the point of sale terminal, wherein the receipt generator generates a digital receipt in response to the print request; and
a central server operably connected to the receipt generator wherein the central server receives the digital receipt.

2. The system of claim 1, wherein the central server is selected from one of the group consisting of a receipt database, an email server, communication server, receipt storage databases, data analysis tools, and value added applications.

3. The system of claim 1, wherein the receipt generator is operably connected to the point of sale terminal by one of the groups consisting of short-range wireless connectivity, a wired network connection, a USB connection and a parallel port.

4. The system of claim 1, wherein the receipt generator is adapted to install digital receipt generator software on the point of sale terminal when the receipt generator is connected to the point of sale terminal.

5. The system of claim 1, wherein the receipt generator comprises a keypad.

6. The system of claim 1, wherein the receipt generator uses radio frequency identification to identify the user.

7. The system of claim 1, further comprising a mobile device that receives the digital receipt from the central server.

8. The system of claim 1, wherein the digital receipt comprises transaction data, user identification, merchant data and the device's identification number.

9. The system of claim 1, wherein the receipt generator further comprises a screen for the user to review data.

10. A method for generating a digital receipt comprising:
processing transaction data at a point of sale terminal;
intercepting a print request from the point of sale terminal;
receiving the print request at a receipt generator operably connected to the point of sale terminal;
generating a digital receipt; and
forwarding the digital receipt to a central server.

11. The method of claim 10, further comprising prompting a user to accept or decline a digital receipt.

12. The method of claim 11, further comprising entering a unique identifier into the digital receipt generator.

13. The method of claim 12, wherein the unique identifier is selected from the group consisting of a phone number, an email address or a magnetic strip card identifier.

14. The method of claim 10, further comprising forwarding the print request to a point of sale printer.

15. The method of claim 10, wherein the digital receipt comprises transaction data, user identification, merchant data and the device's identification number.

16. The method of claim 10, further comprising identifying a user to receive a digital receipt with radio frequency identification.

17. The method of claim 10, further comprising prompting a user to choose whether to receive a paper receipt.

18. The method of claim 10, wherein the receipt generator installs digital receipt generator software on the point of sale terminal when the receipt generator is connected to the point of sale terminal.

19. A digital receipt generator comprising:
connecting means adapted for connecting to a point of sale terminal;
receiving means for receiving the print request from the point of sale terminal;
generating means for generating a digital receipt from the print request;
a customer interface for entering user supplied information; and
transmitting means for transmitting the digital receipt to a central server.

20. The digital receipt generator of claim 19, wherein the digital receipt comprises transaction data, user identification, merchant data and the device's identification number.
